(19) United States
(12) Patent Application Publication
(10) Pub. No.: US 2026/0205715 A1
(43) Pub. Date: Jul. 16, 2026

(54) VOLTAGE ADJUSTING CIRCUIT AND IMAGE SENSOR INCLUDING THE SAME

(71) Applicant: Samsung Electronics Co., Ltd., Suwon-si (KR)

(72) Inventor: Masahiro Ichihashi, Yokohama-shi (JP)

(73) Assignee: Samsung Electronics Co., Ltd., Suwon-si (KR)

(21) Appl. No.: 19/288,307

(22) Filed: Aug. 1, 2025

(30) Foreign Application Priority Data
Jan. 14, 2025 (JP) 2025-004726
Apr. 3, 2025 (KR) 10-2025-0043684

(51) Int. Cl. H04N 25/709; H04N 25/67; H04N 25/76

(52) U.S. Cl. CPC H04N 25/709; H04N 25/76; H04N 25/67

(57) ABSTRACT

A voltage adjusting circuit is configured to generate a dummy current based on a first voltage applied to a load circuit by a power source, and a second voltage generated from a voltage of the power source and used as a reference for the first voltage, and to suppress fluctuations of the first voltage by applying, to the first voltage, an increase or a decrease of voltage by the dummy current.

### CROSS-REFERENCE TO RELATED APPLICATIONS

This present application claims priority to and the benefit under 35 U.S.C. §119(a)-(d) Korean Patent Application No. 10-2025-0043684 filed on Apr. 3, 2025, in the Korean Intellectual Property Office and Japanese Patent Application No. 2025-004726 filed on Jan. 14, 2025 in the Japan Patent Office, the entire disclosures of which are incorporated herein by reference.

### BACKGROUND

Example embodiments of the present disclosure relate to a voltage adjusting circuit and an image sensor including the same.

Recently, devices including cameras, such as a mobile phone and a digital camera, have been designed to be miniaturized and to have high definition. Along with high definition of such devices, sizes of circuits included in an image sensor mounted on the devices have also increased.

In particular, due to an increase in a size of digital circuits included in an image sensor, current consumption of the digital circuits may increase, and accordingly, a peak of current flowing in the digital circuits may suddenly and significantly change. Accordingly, a voltage of a power line supplying power to each component of the image sensor may suddenly and significantly change. The voltage fluctuation of the power line may cause malfunctions and failures of each component of the image sensor. For example, the voltage fluctuation of the power line may affect the analog circuit, such that image quality of an image generated by the image sensor may deteriorate.

In relation to the above, Japanese Laid-Open Patent Publication No. 2000-164810 discloses a technique for suppressing excessive operating current by detecting an operating current of a main circuit (a circuit of an original function) and flowing a compensation current, inversely phased to an operating current, and synthesizing the current in a chip.

Also, as a technique for suppressing voltage fluctuation of a power line, a technique for smoothing a voltage of a power line by connecting a dummy logic circuit to the power line and flowing a dummy current into a dummy logic circuit, and compensating for a decrease in a current flowing in a digital circuit.

### SUMMARY

Example embodiments of the present disclosure is to provide a voltage adjusting circuit which may add a dummy current at appropriate timing while reducing an increase in power consumption, an increase in circuit area, and an increase in leakage current due to suppression of voltage fluctuations, and an image sensor including the same.

According to example embodiments of the present disclosure, a voltage adjusting circuit is configured to generate a dummy current based on a first voltage applied to a load circuit by a power source, and a second voltage generated from a voltage of the power source and used as a reference for the first voltage, and configured to suppress fluctuation of the first voltage by applying, to the first voltage, a voltage drop by the dummy current.

According to example embodiments of the present disclosure, an image sensor including an analog circuit portion includes a power line configured to apply a first voltage to the digital circuit portion based on a voltage of a power source; and a voltage adjusting circuit configured to suppress fluctuation of the first voltage, wherein the voltage adjusting circuit is the voltage adjusting circuit as claimed in claim 1.

According to example embodiments of the present disclosure, a voltage adjusting circuit includes a detector portion configured to generate a first voltage signal detecting a first input voltage corresponding to a first voltage applied to a digital circuit portion, and a second voltage signal detecting a reference input voltage corresponding to a reference voltage different from the first voltage; an error amplifier portion configured to output an output voltage corresponding to a difference between the first voltage signal and the second voltage signal; and a dummy current generator portion configured to generate a dummy current causing a voltage drop in the first voltage in response to the output voltage of the error amplifier portion.

According to example embodiments, a method of manufacturing a voltage adjusting circuit includes providing a voltage adjusting circuit configured to generate a dummy current based on a first voltage applied to a load circuit by a power source, and a second voltage generated from a voltage of the power source and used as a reference for the first voltage, and configured to suppress fluctuation of the first voltage by applying, to the first voltage, a voltage drop by the dummy current.
1. According to example embodiments a method of manufacturing an image sensor includes providing a digital circuit portion and an analog circuit portion, providing a power line configured to apply a first voltage to the digital circuit portion based on a voltage of a power source, and providing a voltage adjusting circuit configured to suppress fluctuation of the first voltage, wherein the voltage adjusting circuit is the voltage adjusting circuit is configured to generate a dummy current based on a first voltage applied to a load circuit by a power source, and a second voltage generated from a voltage of the power source and used as a reference for the first voltage, and configured to suppress fluctuation of the first voltage by applying, to the first voltage, a voltage drop by the dummy current.

### BRIEF DESCRIPTION OF DRAWINGS

The above and other aspects, features, and advantages of the present disclosure will be more clearly understood from the following detailed description, taken in combination with the accompanying drawings, in which:

FIG. 1 is a block diagram illustrating a semiconductor integrated circuit device according to example embodiments of the present disclosure;

FIG. 2 is a block diagram illustrating voltage fluctuations of a power line in a general semiconductor integrated circuit device not including a dummy logic circuit;

FIG. 3A is a graph indicating changes in a current flowing in a digital circuit illustrated in FIG. 2 over time;

FIG. 3B is a graph indicating changes in a voltage of the power line illustrated in FIG. 2 over time;

FIG. 4 is a block diagram illustrating a voltage adjusting circuit illustrated in FIG. 1;

FIGS. 5A, 5B, 5C and 5D is a waveform diagram illustrating operations of a voltage adjusting circuit illustrated in FIG. 4;

FIG. 6 is a circuit diagram illustrating a voltage adjusting circuit illustrated in FIG. 1;

FIG. 7A is a diagram illustrating a portion of a voltage adjusting circuit implementing first and second level-shift circuits using a PMOS type level-shift circuit according to example embodiments of the present disclosure;

FIG. 7B is a diagram illustrating a portion of a voltage adjusting circuit implementing first and second level-shift circuits using a source follower type level-shift circuit according to example embodiments of the present disclosure;

FIG. 8A is a waveform diagram illustrating an input waveform when a low-pass filter circuit is used according to example embodiments of the present disclosure;

FIG. 8B is a waveform diagram illustrating an output waveform when a low-pass filter circuit is used according to example embodiments of the present disclosure;

FIG. 9A is a waveform diagram illustrating an input waveform when a peak hold circuit is used according to example embodiments of the present disclosure;

FIG. 9B is a waveform diagram illustrating an output waveform when a peak hold circuit is used according to example embodiments of the present disclosure;

FIG. 10 is a waveform diagram illustrating operations of a voltage adjusting circuit illustrated in FIG. 6 according to example embodiments of the present disclosure;

FIG. 11 is a block diagram illustrating an image sensor including a voltage adjusting circuit illustrated in FIG. 1 according to example embodiments of the present disclosure;

FIG. 12 is a block diagram illustrating an analog circuit portion illustrated in FIG. 1 according to example embodiments of the present disclosure;

FIG. 13 is a circuit diagram illustrating a comparator illustrated in FIG. 12 according to example embodiments of the present disclosure;

FIG. 14 is a circuit diagram illustrating interference of a comparator due to voltage fluctuations of a power line according to example embodiments of the present disclosure;

FIG. 15 is a diagram illustrating mismatch of timings due to interference of a comparator in a correlated double sampling operation according to example embodiments of the present disclosure;

FIG. 16 is a waveform diagram illustrating a ramp signal and a pixel signal when a period of noise is relatively long for a time period of a correlated double sampling operation according to example embodiments of the present disclosure;

FIG. 17 is a waveform diagram illustrating a ramp signal and a pixel signal when a period of noise is relatively short for a time period of a correlated double sampling operation according to example embodiments of the present disclosure; and

FIG. 18 is a graph indicating gain frequency characteristics of first and second low-pass filter circuits according to example embodiments of the present disclosure.

### DETAILED DESCRIPTION

Hereinafter, embodiments of the present disclosure will be described as below with reference to the accompanying drawings.

In the drawings, same elements will be indicated by same reference numerals. In the diagram, the size of each component is represented in a different ratio from the actual state for clarity and ease of description. The example embodiments described below are merely examples, and various modifications may be made from the example embodiments.

The terms “upper portion” or “upper” may include “being in direct contact with the other and disposed thereon,” and also “not being in contact.”

An expression used in the singular encompasses the expression of the plural, unless it has a clearly different meaning in the context. Also, the configuration in which a portion “includes” or “has” an element does not exclude that the other element is included, and may indicate that the other element may be further included, unless otherwise indicated.

Also, the use of the term “the” and similar demonstrative terms may be applied to both singular and plural forms.

As for operations of the method, unless the order is explicitly described or the opposite is stated, the operations may be performed in an appropriate order, and the order in which the operations are described is not necessarily limited to the order in which the operations are described. The use of examples or exemplary terms (e.g., or the like) is intended merely to describe the technical idea, and the scope of the invention is not limited by the examples or exemplary terms, unless otherwise limited by the scope of the claims.

According to the disclosure in Japanese Laid-Open Patent Publication No. 2000-164810, since a compensation current inversely phased to an operating current of a main circuit may flow, the effect of suppressing a transient operating current may be obtained. However, in the disclosure in cited document 1, a transient operating current may be excessively suppressed, such that the side effect in which a consumption current may increase may become greater than the effect of smoothing an operating current.

Also, the technique for suppressing voltage fluctuations by a dummy logic circuit may have four tasks as below.
1. It may be necessary to determine an appropriate timing for adding a dummy current.
2. When adding a dummy current, when the dummy current is excessively small, the effect of suppressing voltage fluctuations may not be sufficiently obtained, whereas when the dummy current is excessively large, the side effect of increased consumption current may be prominent. Thus, it may be necessary to control a magnitude of the dummy current by considering the balance between the effect of suppressing voltage fluctuations and the increase in power consumption due to the dummy current.
3. To flow a dummy current close to a maximum peak current of a digital circuit, a dummy logic circuit including a similar number of gates to the number of gates of the digital circuit may be required. Accordingly, the circuit area may increase.
4. Recently, in an integrated circuit using a sub-micron process, as a circuit may become finer and the number of gates may increase, such that leakage current may tend to increase. In a digital circuit, an increase in the number of gates may result in an increase in leakage current, such that consumption current in a standby mode may increase.

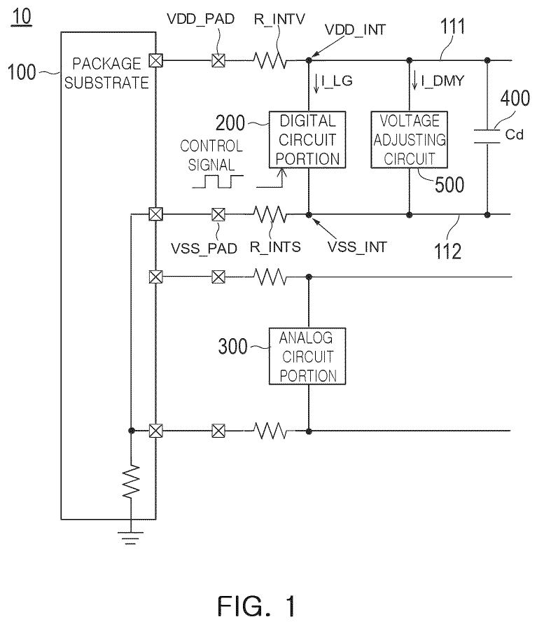

FIG. 1 is a block diagram illustrating a semiconductor integrated circuit device according to example embodiments.

The semiconductor integrated circuit device 10 may automatically suppress fluctuations of a power line 111 by analogically detecting fluctuations of a voltage VDD_INT of the power line 111 and applying a feedback to the voltage VDD_INT of the power line 111 using a detection result.

According to example embodiments, the semiconductor integrated circuit device 10 may include a digital circuit portion 200, an analog circuit portion 300, an on-chip decoupling capacitor 400, and a voltage adjusting circuit 500 formed on a package substrate 100. The digital circuit portion 200, the analog circuit portion 300, and the voltage adjusting circuit 500 may be connected to a power circuit through power pads VDD_PAD and VSS_PAD. Power may be supplied to the digital circuit portion 200, the analog circuit portion 300, and the voltage adjusting circuit 500 from the power circuit.

The digital circuit portion 200 may include at least one digital (logic) circuit configured as a logic gate circuit or a memory. In example embodiments, when the semiconductor integrated circuit device 10 is configured as an image sensor, the digital circuit portion 200 may include, for example, an image signal processing portion, or the like. The digital circuit portion 200 may correspond to a load circuit in the semiconductor integrated circuit device 10. An example of the configuration of the image sensor will be described later. Each of digital circuits of the digital circuit portion 200 may be controlled by a control signal generated by, for example, a central processing unit (CPU), or the like.

In the semiconductor integrated circuit device 10, a positive power voltage VDD and a negative power voltage VSS output by the power circuit may be supplied as power to each portion through the power pad VDD_PAD and the power pad VSS_PAD, respectively, formed on a package substrate 100. A wiring from the power pad VDD_PAD and the power pad VSS_PAD to the digital circuit portion 200 may include wiring resistors R_INTV and R_INTS. Accordingly, a voltage of the positive side of the digital circuit portion 200 may be the voltage VDD_INT obtained by subtracting a voltage drop by the wiring resistor R_INTV from the voltage of the power pad VDD_PAD. Also, the voltage of the negative side of the digital circuit portion 200 may be the voltage VSS_INT obtained by subtracting a voltage drop by the wiring resistor R_INTS from a potential of the power pad VSS_PAD. A voltage corresponding to a difference between the voltage VDD_INT and the voltage VSS_INT may be applied to the digital circuit portion 200.

The analog circuit portion 300 may include at least one analog circuit including a photoelectric conversion element or a transistor circuit, or the like. For example, when the semiconductor integrated circuit device 10 is configured as an image sensor, the digital circuit portion 200 may include an analog-digital converter portion. The configuration of the analog-digital converter portion will also be described later.

As for the analog circuit portion 300, similarly to the above-described digital circuit portion 200, a voltage corresponding to the difference in voltage obtained by subtracting a voltage drop due to wiring resistor from each of the positive side and the negative side may be applied.

The on-chip decoupling capacitor 400 may be connected between the power line 111 and the power line 112 and may absorb voltage fluctuations occurring in the power line. In example embodiments, since voltage fluctuations of the power line 111 and the power line 112 are suppressed by the voltage adjusting circuit 500, the on-chip decoupling capacitor 400 may be implemented as a capacitor having a small capacity. Accordingly, the increase in circuit area due to the on-chip decoupling capacitor 400 may be suppressed.

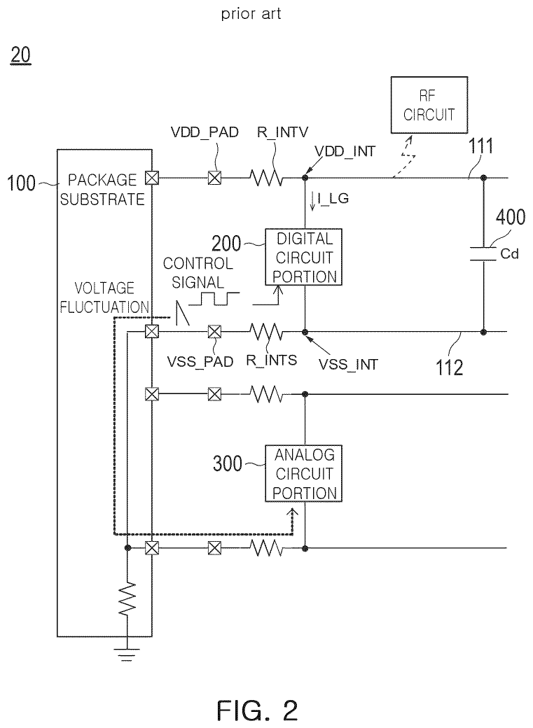

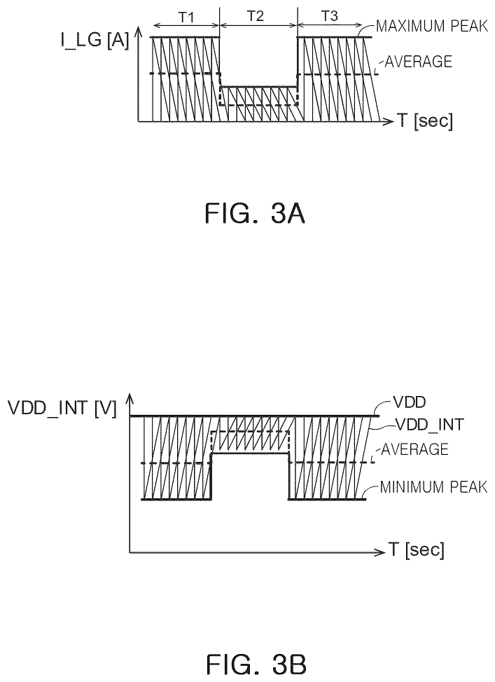

The voltage adjusting circuit 500 may smooth the voltage VDD_INT of the power line 111 by suppressing fluctuations of the voltage VDD_INT of the power line 111. Hereinafter, fluctuations of the voltage VDD_INT of the power line 111 in the semiconductor integrated circuit device 10 will be described with reference to FIGS. 2, 3A, and 3B, and the configuration and function of the voltage adjusting circuit 500 according to example embodiments will be described in detail. By suppressing the voltage fluctuations of the power line 111, the voltage fluctuations of the power line 112 may also be suppressed simultaneously, and accordingly, a detailed description of the suppression of the voltage fluctuations of the power line 112 may not be provided.

FIG. 2 is a block diagram illustrating voltage fluctuations of a power line in a general semiconductor integrated circuit device not including a dummy logic circuit. FIG. 3A is a graph indicating changes in a current flowing in a digital circuit illustrated in FIG. 2 over time. FIG. 3B is a graph indicating changes in a voltage of the power line illustrated in FIG. 2 over time.

As illustrated in FIG. 2, the general semiconductor integrated circuit device 20 may include a digital circuit portion 200, an analog circuit portion 300, and an on-chip decoupling capacitor 400 formed on a package substrate 100. The general semiconductor integrated circuit device 20 illustrated in FIG. 2 may not have a component corresponding to a voltage adjusting circuit 500 according to example embodiments.

A current I_LG flowing in the digital circuit portion 200 may vary depending on the size or the number of digital circuits driven in the digital circuit portion 200. For example, when a digital circuit having a relatively large circuit size and a large consumption current is driven, or when a plurality of digital circuits are driven even though each consumption current is relatively small, the current I_LG may increase.

In the example embodiments, for example, as illustrated in FIG. 3A, a line connecting maximum values of a current I_LG which changes over time, that is, an envelope of the maximum value of the current I_LG, may be referred to as a maximum peak of the current I_LG. Similarly, as illustrated in FIG. 3B, a line connecting minimum values of a voltage VDD_INT which changes over time, that is, an envelope of the minimum value of the voltage VDD_INT, may be referred to as a minimum peak of the voltage VDD_INT.

Referring to FIG. 3A, the current I_LG which changes over time may be represented by a thin solid line, and the maximum peak of the current I_LG and an average of the current I_LG may be represented by a thick solid line and a dashed line, respectively. The maximum peak and the average of the current I_LG may decrease rapidly from period T1 to period T2, and may increase rapidly from period T2 to period T3. From the waveform of this current I_LG, for example, in the digital circuit portion 200, it may be inferred that at least a portion of the digital circuit is switched from being turned on to being turned off during the transition from the period T1 to the period T2, and at least a portion of the digital circuit is switched from being turned off to being turned on during the transition from the period T2 to the period T3.

Also, as illustrated in FIG. 3B, the voltage VDD_INT of the power line 111 may change according to fluctuations of the current I_LG. A minimum peak of the voltage VDD_INT of the power line 111 may change according to the change of the maximum peak of the current I_LG. Referring to FIG. 3B, the VDD represented by the thick solid line may correspond to the voltage of a pad of the package substrate 100. Also, the voltage VDD_INT, which fluctuates according to fluctuations of the current I_LG, may be represented by a thin solid line, and the minimum peak value and the average of the voltage VDD_INT may be represented by a thick solid line and a thin dashed line, respectively. In the period T1, the minimum peak and the average of the voltage VDD_INT may decrease due to a voltage drop in the digital circuit in the digital circuit portion 200 because the current I_LG is large. In the period T2, the minimum peak and the average of the voltage VDD_INT may rapidly increase as the current I_LG decreases, and in the period T3, the minimum peak and the average of the voltage VDD_INT may rapidly decrease due to a rapid increase in the current I_LG.

As described above, in the general semiconductor integrated circuit device 20 not including a dummy logic circuit, fluctuations of the current I_LG in the digital circuit portion 200 may be directly reflected in the voltage VDD_INT of the power line 111.

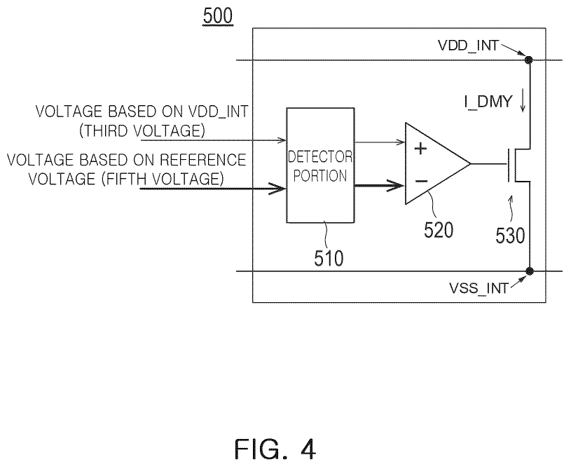

FIG. 4 is a block diagram illustrating a voltage adjusting circuit illustrated in FIG. 1.

Referring to FIG. 4, the voltage adjusting circuit 500 may include a detector portion 510, an error amplifier portion 520, and a dummy current generator portion 530. Hereinafter, a schematic configuration and function of the voltage adjusting circuit 500 will be described. Each portion of the voltage adjusting circuit 500 will be described in detail later.

The detector portion 510 may detect a third voltage and a fifth voltage, and may transfer each detection result to the error amplifier portion 520. More specifically, the detector portion 510 may detect minute fluctuations of the third voltage, and may output components other than the detected fluctuations to the error amplifier portion 520. For example, the first voltage may be a voltage corresponding to a voltage VDD_INT applied to the digital circuit portion 200 by a power source, and the second voltage may be a reference voltage generated from the power voltage and working as a reference for the first voltage. The third voltage may be a voltage based on the voltage VDD_INT, for example, the first voltage, and the fifth voltage may be a voltage based on the reference voltage VDD_REF. More specifically, the third voltage may be obtained by level-shifting the first voltage by a predetermined voltage, and the fifth voltage may be obtained by level-shifting the second voltage by a predetermined voltage and being further level-shifted to adjust a smoothing level of the voltage of the power line 111. The aforementioned level-shifting may be for obtaining an input voltage at which the error amplifier of the error amplifier portion 520 may operate from the first voltage and the second voltage. When the first voltage and the second voltage are within the range of the input voltage at which the error amplifier may operate, the level-shifting may not be provided. The reference voltage VDD_REF may correspond to the reference voltage.

The error amplifier portion 520 may compare a detection result of the third voltage by the detector portion 510 with a detection result of the fifth voltage, and may output the output voltage VOUTP, which is a comparison result, to the dummy current generator portion 530. The error amplifier portion 520 may include, for example, a differential amplifier may control an output voltage of the differential amplifier such that the difference (error) between the detection result of the third voltage and the detection result of the fifth voltage by the detector portion 510 may approach 0.

The dummy current generator portion 530 may generate a dummy current flowing between the power line 111 and the power line 112. The magnitude of the dummy current may be adjusted by the output voltage of the error amplifier portion 520. As described above, the dummy current generator portion 530 may be implemented by a current source including, for example, a MOSFET for generating the dummy current. The dummy current may be controlled by a voltage Vgs between a gate-source of the MOSFET of the current source. By implementing the current source of the dummy current by the MOSFET, the circuit size of the dummy current generator portion 530 may be reduced.

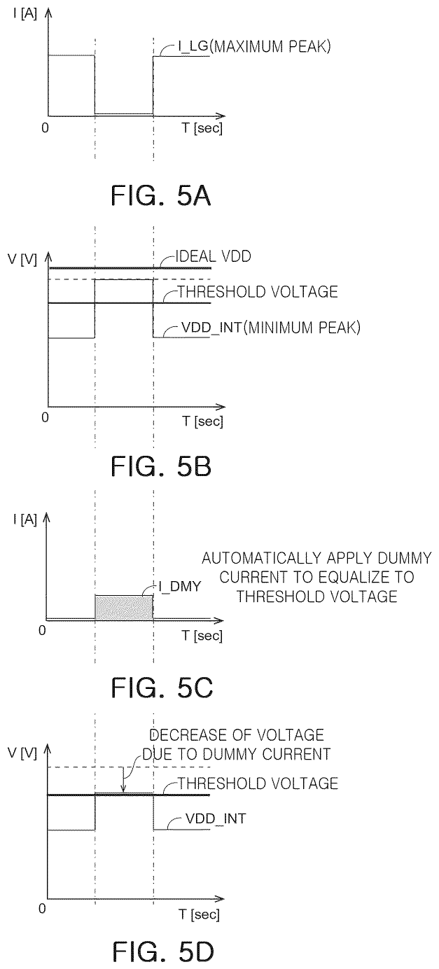

In the description below, an example of operations of the voltage adjusting circuit 500 may be described with reference to FIGS. 5A, 5B, 5C and 5D. FIGS. 5A, 5B, 5C and 5D are a waveform diagram illustrating operations of the voltage adjusting circuit 500 illustrated in FIG. 4. FIG. 5A is a waveform diagram illustrating changes in a maximum peak of the current I_LG flowing in the digital circuit portion 200 over time. FIG. 5B is a waveform diagram illustrating changes in a minimum peak and a threshold voltage of the voltage VDD_INT of the power line over time when no dummy current is added. FIG. 5C is a waveform diagram illustrating changes in the generated dummy current I_DMY over time. FIG. 5D is a waveform diagram illustrating changes in the voltage VDD_INT of the power line over time when the dummy current I_DMY is added. The level-shifting for the described voltage VDD_INT and the reference voltage VDD_REF may be applied equally by a predetermined voltage, the relative magnitude relationship between the voltage VDD_INT and the reference voltage VDD_REF may be maintained without changing before and after the level-shifting. Accordingly, in the example embodiment illustrated in FIGS. 5A, 5B, 5C and 5D, instead of presenting the relationship between the third voltage and the fifth voltage, the relationship between the voltage VDD_INT and the threshold voltage may be illustrated.

For example, it may be assumed that the maximum peak of the current I_LG flowing in the digital circuit portion 200 changes as illustrated in FIG. 5A. In this case, as illustrated in FIG. 5B, the minimum peak of the voltage VDD_INT of the power line may change according to the maximum peak of the current I_LG flowing in the digital circuit portion 200. The voltage VDD_INT may be obtained by subtracting a voltage drop due to the digital circuit portion 200 or the wiring resistor R_INTV from the ideal VDD (e.g., pad voltage).

In example embodiments, as illustrated in FIG. 5C, a dummy current may be automatically generated in the voltage adjusting circuit 500 according to the difference between the third voltage and the fifth voltage, and a voltage drop may occur due to the dummy current. As illustrated in FIG. 5D, the dummy current may be adjusted such that the third voltage, which is a voltage based on the voltage VDD_INT, may be equalized to the fifth voltage, which is a voltage based on the reference voltage.

That is, the voltage adjusting circuit 500 may automatically generate a dummy current by comparing the third voltage to the fifth voltage such that the difference between the voltages is reduced. The fifth voltage, which determines whether to generate the dummy current, may function as a threshold voltage for generating the dummy current. As described above, the fifth voltage may be arbitrarily changed by adjusting the voltage drop in the smoothing level adjusting circuit 503. Also, the fifth voltage may be changed between the maximum peak and the minimum peak of the third voltage. For example, the smoothing level may increase as the fifth voltage approaches the minimum peak of the third voltage, and the smoothing level may decrease as the fifth voltage approaches the maximum peak of the third voltage. The consumption current by the dummy current may increase as the fifth voltage approaches the minimum peak of the third voltage, and may decrease as the fifth voltage approaches the maximum peak of the third voltage.

As described above, the smoothing degree of the voltage VDD_INT and the magnitude of the consumption current by the dummy current may have a trade-off relationship. For example, by changing the threshold voltage of the dummy current generation, the balance between the smoothing degree of the voltage VDD_INT and the magnitude of the consumption current may be easily adjusted.

The voltage adjusting circuit 500 may generate a dummy current based on the first voltage VDD_INT applied to the digital circuit portion 200 as a load circuit by the power source and the reference voltage as the second voltage. Also, a voltage drop by the dummy current may be applied to the first voltage, and the output voltage of the differential amplifier may be controlled such that the difference between the detection result in which detector portion 510 detects the third voltage and the detection result in which detector portion 510 detects the fifth voltage approaches 0, thereby pressing the fluctuations of the first voltage. Accordingly, the voltage VDD_INT of the power line 111 may be smoothed.

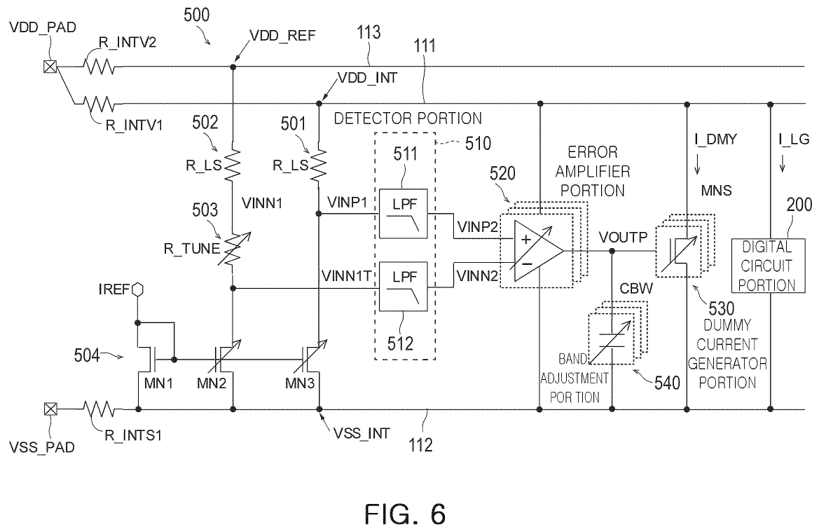

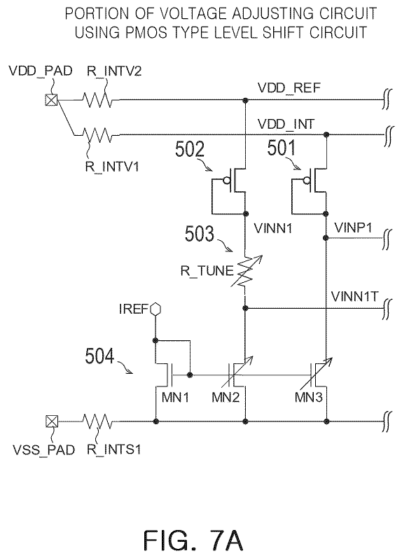

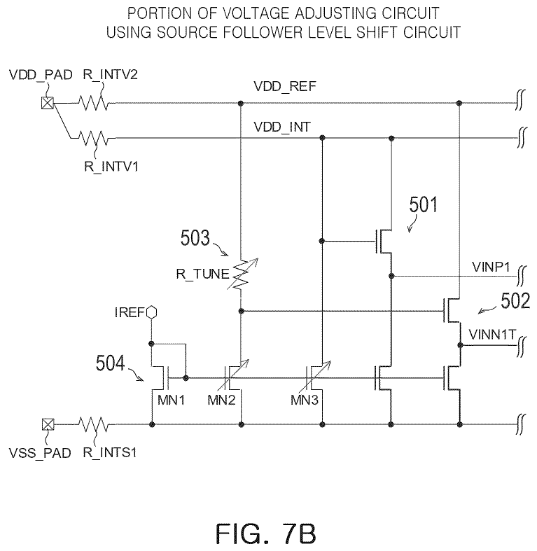

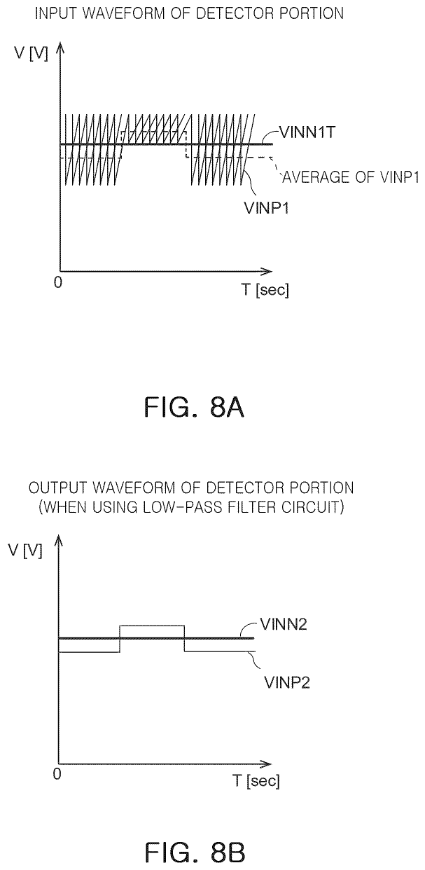

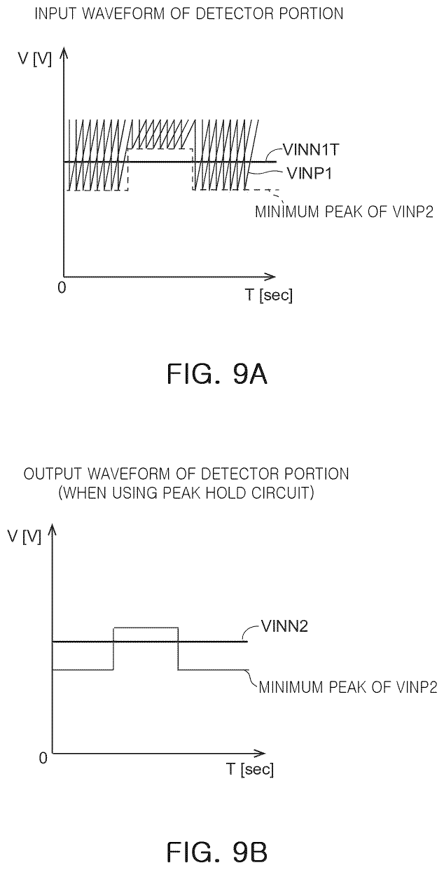

FIG. 6 is a circuit diagram illustrating a voltage adjusting circuit illustrated in FIG. 1. FIG. 7A is a diagram illustrating a portion of a voltage adjusting circuit implementing first and second level-shift circuits using a PMOS type level-shift circuit according to example embodiments. FIG. 7B is a diagram illustrating a portion of a voltage adjusting circuit implementing first and second level-shift circuits using a source follower type level-shift circuit according to example embodiments. FIG. 8A is a waveform diagram illustrating an input waveform when a low-pass filter circuit is used according to example embodiments. FIG. 8B is a waveform diagram illustrating an output waveform when a low-pass filter circuit is used according to example embodiments. FIG. 9A is a waveform diagram illustrating an input waveform when a peak hold circuit is used according to example embodiments. FIG. 9B is a waveform diagram illustrating an output waveform when a peak hold circuit is used according to example embodiments.

As illustrated in FIG. 6, the voltage adjusting circuit 500 may include a first level-shift circuit 501, a second level-shift circuit 502, a smoothing level adjusting circuit 503, a constant current circuit 504, a detector portion 510, an error amplifier portion 520, a dummy current generator portion 530, and a band adjustment portion 540.

The first level-shift circuit 501 may generate a third voltage, which is an input voltage at which an error amplifier of the error amplifier portion 520 may operate, from the first voltage VDD_INT. The second level-shift circuit 502 may generate a fourth voltage, which is a range of the input voltage, from the second voltage VDD_REF. Each of the first level-shift circuit 501 and the second level-shift circuit 502 may include, for example, a resistor circuit. The first level-shift circuit 501 and the second level-shift circuit 502 may generate the third voltage VINP1 and the fourth voltage VINN1 from the levels of the first voltage and the second voltage, respectively, by a voltage drop due to the current flowing in the resistor circuit. The third voltage VINP1 and the fourth voltage VINN1 may be included in the range of the input voltage in which the error amplifier may operate. When the first voltage VDD_INT and the second voltage VDD_REF are included in the range of the input voltage in which the error amplifier may operate, it may not be necessary to perform level-shifting such that the first level-shift circuit 501 and the second level-shift circuit 502 may not be provided.

For example, in the example embodiment illustrated in FIG. 6, each of the first level-shift circuit 501 and the second level-shift circuit 502 may include a resistor circuit including a resistor R_LS. One node of the resistor R_LS of the first level-shift circuit 501 may be connected to the power line 111, and the other node may be connected to a drain terminal of a metal-oxide-semiconductor field effect transistor (MOSFET) MN3 on the output side of the current mirror circuit included in the constant current circuit 504. Also, one node of the resistor R_LS of the second level-shift circuit 502 may be connected to the reference line 113, and the other node may be connected to a node of the variable resistor circuit R_TUNE of the smoothing level adjusting circuit 503. The reference line 113 may be connected to the power pad VDD_PAD through the resistor R_INTV2.

Also, as illustrated in FIG. 7A, each of the first level-shift circuit 501 and the second level-shift circuit 502 may include a PMOS type circuit. In the PMOS type circuit, a voltage drop may occur due to the current flowing between the source and the drain by diode connection in which the drain terminal and the gate terminal of the P-channel MOSFET are connected to one another. The third voltage VINP1 may be generated from the first voltage VDD_INT by the first level-shift circuit 501, and the fourth voltage VINN1 may be generated from the reference voltage VDD_REF, which is the second voltage, by the second level-shift circuit 502.

Alternatively, as illustrated in FIG. 7B, each of the first level-shift circuit 501 and the second level-shift circuit 502 may include a source follower circuit. In the source follower circuit of the first level-shift circuit 501, the third voltage VINP1, obtained by subtracting the voltage Vgs between gate-source from the first voltage VDD_INT, which is the input voltage of the gate of the N-channel MOSFET. In the source follower circuit of the second level-shift circuit 502, the fourth voltage VINN1T, obtained by subtracting the voltage Vgs between gate-source from the input voltage of the gate of the N-channel MOSFET.

Referring back to FIG. 6, the smoothing level adjusting circuit 503 may adjust the smoothing level of the first voltage VDD_INT. The smoothing level adjusting circuit 503 may include, for example, a variable resistor circuit R_TUNE. One node of the variable resistor circuit R_TUNE may be connected to the second level-shift circuit 502, and the other node may be connected to the drain terminal of the output-side MOSFET MN2 of the current mirror circuit included in the constant current circuit 504. The voltage VINN1T may be output by the output terminal of the variable resistor circuit R_TUNE by a voltage drop in the variable resistor circuit R_TUNE. The smoothing of the first voltage VDD_INT by the smoothing level adjusting circuit 503 will be described in detail later.

The constant current circuit 504 may include a current mirror circuit. The current mirror circuit may include an input-side MOSFET MN1, and an output-side MOSFETs MN2 and MN3. The current mirror circuit may flow a current having the same magnitude as a predetermined current IREF to the output-side MOSFETs MN2 and MN3.

Instead of the smoothing level adjusting circuit 503, the smoothing level of the first voltage VDD_INT may be adjusted by adjusting the drain-source current flowing through the output-side MOSFET MN2 of the current mirror circuit included in the constant current circuit 504. By adjusting the current flowing through the output-side MOSFET MN2, the voltage drop in the variable resistor circuit R_TUNE of the smoothing level adjusting circuit 503 may be adjusted.

The detector portion 510 may input a third voltage generated by the first level-shift circuit 501, and a fifth voltage generated by the second level-shift circuit 502 and the smoothing level adjusting circuit 503, and may output a voltage signal detecting the third voltage and a voltage signal detecting the fifth voltage. The detector portion 510 may include a first low-pass filter circuit (LPF) 511, and a second low-pass filter circuit 512. Hereinafter, the first low-pass filter circuit 511 and the second low-pass filter circuit 512 may be referred to as a first LPF 511 and a second LPF 512, respectively. An input terminal of the first LPF 511 may be connected to the other node of the resistor R_LS of the first level-shift circuit 501, and an output terminal of the first LPF 511 may be connected to a non-inverting input terminal of an error amplifier included in the error amplifier portion 520. Also, the input terminal of the second LPF 512 may be connected to the other node of the variable resistor circuit R_TUNE included in the smoothing level adjusting circuit 503, and the output terminal of the second LPF 512 may be connected to the inverting input terminal of the error amplifier included in the error amplifier portion 520.

The third voltage VINP1 may be input to the input terminal of the first LPF 511, and the voltage VINN1T may be input to the input terminal of the second LPF 512. As illustrated in FIG. 8A, the third voltage VINP1 may be represented by a thin solid line, and the voltage VINN1T may be represented by a thick solid line. Also, the average of the third voltage VINP1 may be represented by a thin dashed line.

The first LPF 511 may block the high-band component of the cutoff frequency Fc or higher in the third voltage VINP1, and may allow the low-band component of lower than the cutoff frequency Fc to pass through. Accordingly, as illustrated in FIG. 8B, the first LPF 511 may output a voltage VINP2 corresponding to the average of the input third voltage VINP1 to the output terminal (thin solid line in FIG. 8B). The second LPF 512 may allow the input voltage VINN1T to pass through as is and may output the voltage VINN2 to the output terminal (the thick solid line in FIG. 8B).

The example in which the detector portion 510 includes a low-pass filter is illustrated, but the detector portion 510 may be implemented to include a peak hold circuit instead of a low-pass filter. For example, it may be assumed that the third voltage VINP1 is input to the input terminal of the first peak hold circuit and the voltage VINN1T is input to the input terminal of the second peak hold circuit. When the detector portion 510 includes a peak hold circuit, the DC level of the voltage VINN1T may be configured to be lower than the DC level of the voltage VINN1T illustrated in FIG. 8A. In the example embodiment illustrated in FIG. 9A, the third voltage VINP1 may be illustrated as a thin solid line, and the voltage VINN1T may be illustrated as a thick solid line. Also, the envelope of the minimum value of the third voltage VINP1 may be illustrated as a thin dashed line.

The first peak hold circuit may maintain the envelope of the minimum value of the third voltage VINP1 which changes over time, that is, the envelope of the minimum value of the third voltage VINP1, as the voltage VINP2 of the minimum peak, and may output the voltage to the output terminal. Also, the voltage VINN1T may be a DC voltage, and thus, the second peak hold circuit may output the voltage VINN1T as voltage VINN2 as is.

The error amplifier portion 520 may input the voltage VINP2 and the voltage VINN2 detected by the detector portion 510 to the error amplifier, and may output an output voltage VOUTP corresponding to the difference between the voltage VINP2 and the voltage VINN2 to the dummy current generator portion 530. The error amplifier portion 520 may include at least one error amplifier. For example, the error amplifier portion 520 may include a plurality of error amplifiers connected to one another in parallel. Each of the non-inverting input terminals of the plurality of error amplifiers may be connected to an output terminal of the first LPF 511, and an inverting input terminal may be connected to an output terminal of the second LPF 512. Each of the output terminals of the plurality of error amplifiers may be connected to an input terminal of the dummy current generator portion 530. The number of error amplifiers may be configured experimentally or empirically by, for example, entering a predetermined value into a memory by the central processing unit by a user.

The dummy current generator portion 530 may generate and output a dummy current I_DMY according to the output voltage of the error amplifier portion 520. The dummy current generator portion 530 may include at least one current source. For example, the dummy current generator portion 530 may have a plurality of current sources connected to one another in parallel. The current source may be configured as, for example, an NMOSFET, and a constant current may be controlled by a voltage Vgs between the gate and the source of the NMOSFET. The number of current sources may be configured experimentally or empirically by, for example, entering a predetermined value into a memory by the central processing unit by a user.

The band adjusting portion 540 may adjust the band of the error amplifier portion 520. An input terminal of the band adjusting portion 540 may be connected to an output terminal of the error amplifier portion 520, and an output terminal of the band adjusting portion 540 may be connected to a power line 112. The band adjusting portion 540 may include at least one band adjusting capacitor. For example, the band adjusting portion 540 may include a plurality of band adjusting capacitors connected to one another in parallel. The number of the band adjusting capacitors may be configured experimentally or empirically by, for example, entering a predetermined value into a memory by a central processing unit by a user. The value of the band adjusting capacitor may be predetermined experimentally or empirically by a user.

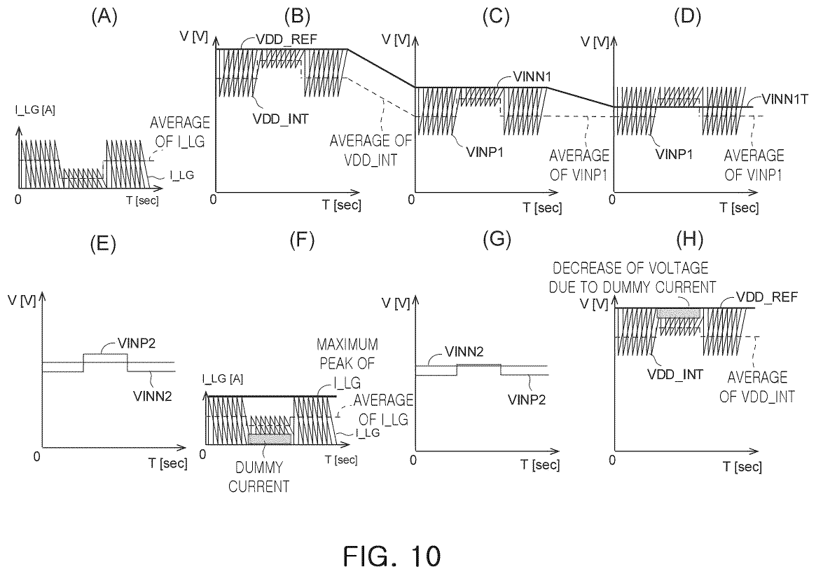

FIG. 10 is a waveform diagram illustrating operations of a voltage adjusting circuit illustrated in FIG. 6 according to example embodiments. FIG. 10(A) is a waveform diagram illustrating the current I_LG flowing in the digital circuit portion 200. FIG. 10(B) is a waveform diagram illustrating the voltage VDD_INT and the reference voltage VDD_REF. FIG. 10(C) is a waveform diagram illustrating the voltage VINN1 and the voltage VINP1, obtained by level-shifting the voltage VDD_INT and the reference voltage VDD_REF, respectively. FIG. 10(D) is a waveform diagram illustrating the voltage VINN1T, obtained by level-shifting the voltage VINN1. FIG. 10(E) is a waveform diagram illustrating the voltage VINP2 and the voltage VINN2 after detection. FIG. 10(F) is a waveform diagram illustrating the dummy current. FIG. 10(G) is a waveform diagram illustrating the voltage VINP2 and the voltage VINN2 between which a difference becomes zero due to generation of the dummy current. FIG. 10(H) is a waveform diagram illustrating the voltage VDD_INT and the reference voltage VDD_REF of the power line 111 in which fluctuations are suppressed by generation of the dummy current.

As illustrated in FIG. 10(A), a current I_LG fluctuating depending on the load of the digital circuit may flow in the digital circuit portion 200. The average of the current I_LG may be illustrated by a thin dashed line.

As illustrated in FIG. 10(B), the voltage VDD_INT may fluctuate depending on fluctuations of the current I_LG. The reference voltage VDD_REF may be maintained constant regardless of time. The reference voltage VDD_REF may be illustrated by a thick solid line, and the average of the voltage VDD_INT may be illustrated by a thin dashed line.

As illustrated in FIG. 10(C), a voltage VINP1 level-shifted by a voltage drop by the resistor R_LS from the voltage VDD_INT may be generated by the first level-shift circuit 501. Similarly, a voltage VINN1 level-shifted by a voltage drop by the resistor R LS from the reference voltage VDD_REF may be generated by the second level-shift circuit 502.

As illustrated in FIG. 10(D), a voltage VINN1T level-shifted by a voltage drop by the variable resistor circuit R_TUNE from the voltage VINN1 may be generated by the smoothing level adjusting circuit 503.

As illustrated in FIG. 10(E), the voltage VINP1 and the voltage VINN1T may be input to the detector portion 510, and may be detected, and the voltage VINP2 and the voltage VINN2 may be output, respectively.

As illustrated in FIG. 10(F), a dummy current may be generated according to the difference between the voltage VINP2 and the voltage VINN2.

As illustrated in FIG. 10(G), the dummy current may be adjusted such that the difference between the voltage VINP2 and the voltage VINN2 may approach 0 by the error amplifier portion 520. For example, the dummy current may be adjusted such that the difference between voltage VINP2 and voltage VINN2 may become 0.

As illustrated in FIG. 10(H), fluctuations of the voltage VDD_INT of the power line 111 may be suppressed by applying a voltage drop by the dummy current to voltage VDD_INT. As described, the smoothing level of voltage VDD_INT may be adjusted by the threshold voltage (fifth voltage) of generation of the dummy current.

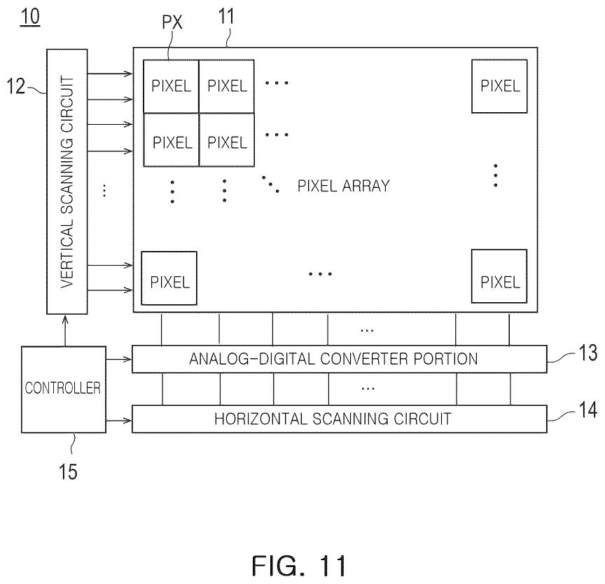

FIG. 11 is a block diagram illustrating an image sensor including a voltage adjusting circuit illustrated in FIG. 1 according to example embodiments.

A pixel array 11 may include a plurality of pixels PX arranged in a two-dimensional manner (matrix arrangement) in the row (ROW) direction and the column (COLUMN) direction. Each of the plurality of pixels PX may include a photoelectric conversion element, a transmission transistor, a reset transistor, an amplifier transistor, and a selection transistor, and may photoelectrically convert incident light and may output an electric signal according to the amount of incident light. The photoelectric conversion element may include, for example, a photodiode, a phototransistor, or the like. The pixel array 11 may output an analog pixel signal for the pixel PX of the row selected by the vertical scanning circuit 12.

The vertical scanning circuit 12 may output a pulse signal to a signal line corresponding to the selected row to select one row from among the plurality of rows included in the pixel array 11. The vertical scanning circuit 12 may include a vertical decoder and a vertical driving circuit. The vertical decoder may select one row from among a plurality of rows by decoding position information of the pixel PX designated by the controller 15 and designating a readout output row in the vertical direction. The vertical driving circuit may drive the pixel PX by supplying a pulse signal to the pixel PX of the readout output row determined by the vertical decoder.

The analog-digital converter portion 13 may include a single slope analog to digital converter (ADC), and a latch circuit. The single slope ADC may be implemented as a circuit configured to convert an analog pixel signal into a digital signal. The latch circuit may hold the converted digital signal as pixel data and may execute CDS processing. By the CDS processing, nonuniformity of the pixel signal in each pixel PX may be removed.

The horizontal scanning circuit 14 may output a pulse signal to a select signal line corresponding to the selected column to select one column from among a plurality of columns included in the pixel array 11. The horizontal scanning circuit 14 may include a horizontal decoder and a horizontal driving circuit. The horizontal decoder may select one column from a plurality of columns by decoding position information of a pixel PX designated by the controller 15 to determine a readout output column in a horizontal direction. The horizontal driving circuit may supply a pulse signal to a latch circuit of the readout output column determined by the horizontal decoder and may read out data held in the latch circuit, that is, data stored in the latch circuit.

The controller 15 may generate a timing signal and a control signal, and may control the vertical scanning circuit 12, the analog-digital converter portion 13, the horizontal scanning circuit 14, or the like, based on the generated signal.

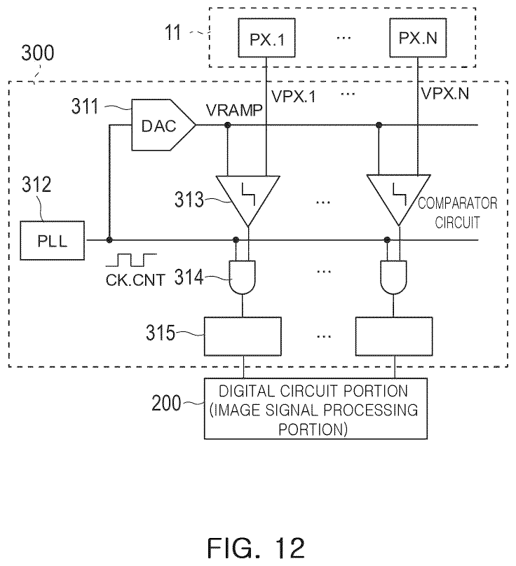

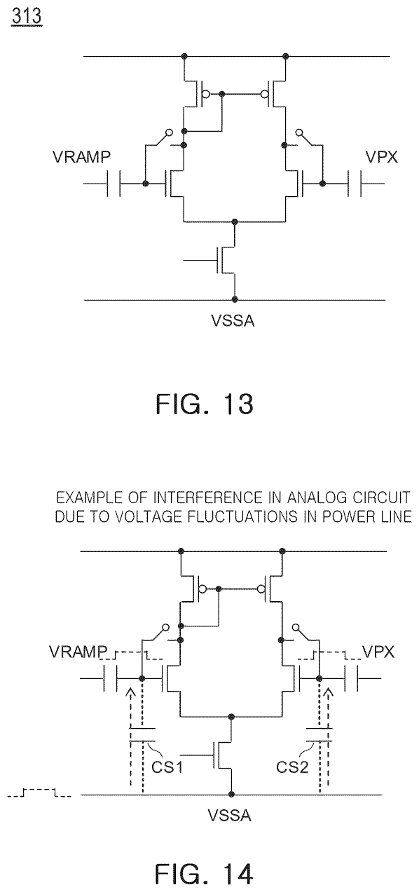

FIG. 12 is a block diagram illustrating an analog circuit portion illustrated in FIG. 1 according to example embodiments. FIG. 13 is a circuit diagram illustrating a comparator illustrated in FIG. 12 according to example embodiments. The analog circuit portion 300 may be, for example, a single slope ADC. A DAC 311, a PLL 312, a comparator 313, an AND element 314, and a counter 315 may be included in the analog circuit portion 300.

As illustrated in FIG. 12, the DAC 311 may be implemented as a DA conversion circuit configured to generate a voltage signal of a ramp waveform (hereinafter, referred to as a ramp signal) of which a voltage level monotonically decreases over time, and to supply the ramp signal to the AD conversion circuit. The AD conversion circuit may convert an analog pixel signal obtained from the pixel PX into a digital signal.

A phase locked loop (PLL) 312 may generate a clock signal CK.CNT having a predetermined period Tcyc.

As illustrated in FIG. 13, a comparator 313 may compare a ramp signal VRAMP generated by the DAC 311 with an analog pixel signal VPX output by the pixel array 11, and may output a comparison result. The analog pixel signal VPX may include pixel signals VPX.1-VPX.N output by each of the pixels PX. The comparison result may have a high level, for example, when the ramp signal VRAMP has a size of the analog pixel signal VPX or more, and may have a low level when the ramp signal VRAMP has a size less than that of the analog pixel signal VPX.

Referring back to FIG. 12, the AND element 314 may calculate a logical AND of the comparison result of the comparator 313 and the clock signal CK. CNT received from the PLL 312. The AND element 314 may output a high level when both the comparison result of the comparator 313 and the clock signal CK. CNT received from the PLL 312 are high levels, and may output a low level when at least one of the comparison result of the comparator 313 and the clock signal CK. CNT from the PLL 312 is low level. Accordingly, the AND element 314 may output the clock signal CK. CNT generated by the PLL 312 when the ramp signal VRAMP is the size of the analog pixel signal VPX or more.

A counter 315 may receive an output signal of the AND element 314 as a clock input and may count the input clock signal CK. CNT. The counter 315 may count the number of clocks of the clock signal CK. CNT until the analog pixel signal VPX and the ramp signal VRAMP intersect. The count result (count value) of the counter 315 may be a digital value obtained by converting the analog pixel signal VPX into a digital signal. The count value of counter 315 may be held in a latch circuit and may be transmitted to an image signal processing portion which is the digital circuit portion 200 after the CDS processing is executed.

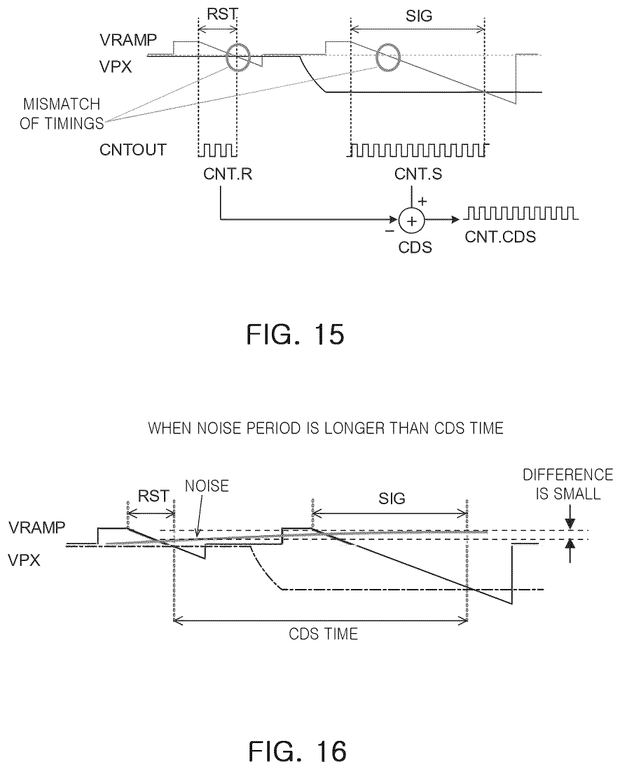

FIG. 14 is a circuit diagram illustrating interference of a comparator due to voltage fluctuations of a power line according to example embodiments. FIG. 15 is a diagram illustrating mismatch of timings due to interference of a comparator in a correlated double sampling operation according to example embodiments.

As an example of interference for the analog circuit portion 300, interference of the comparator 313 included in the analog circuit portion 300 may be described. Voltage fluctuations of the power line 112 may affect the entire comparator 313 as illustrated in FIG. 14. Parasitic capacitances CS1 and CS2 may be formed between gate-source of each of the MOSFETs functioning as the input portions of the ramp signal VRAMP and the analog pixel signal VPX in the comparator 313. Voltage fluctuations of the power line 112 may affect input portions of the ramp signal VRAMP and the analog pixel signal VPX through the parasitic capacitances CS1 and CS2.

As illustrated in FIG. 15, in CDS processing, the latch circuit may execute CDS processing by calculating the difference CNT.CDS between the count value CNT.S corresponding to the analog pixel signal VPX of the signal level and the count value CNT.R corresponding to the analog pixel signal VPX of the reset level. By CDS processing, non-uniformity of the analog pixel signal VPX may be removed from each pixel PX. In other words, by subtracting the count value CNT.R of the counter 315 at the RST phase from the count value CNT.S of the counter 315 at the SIG phase, noise such as fixed pattern noise or reset noise including the non-uniformity in each pixel PX may be removed. Accordingly, the pixel value corresponding to the signal level after noise removal may be extracted.

However, as illustrated in FIG. 14 and FIG. 15, when voltage fluctuations of power line 112 affect the input portion of the ramp signal VRAMP and the analog pixel signal VPX through the parasitic capacitances CS1 and CS2, timing mismatch may occur due to interference of the comparator 313 in CDS processing.

In example embodiments, since voltage fluctuations of the power line 112 may be suppressed by the voltage adjusting circuit 500, interference of the comparator 313 may be reduced.

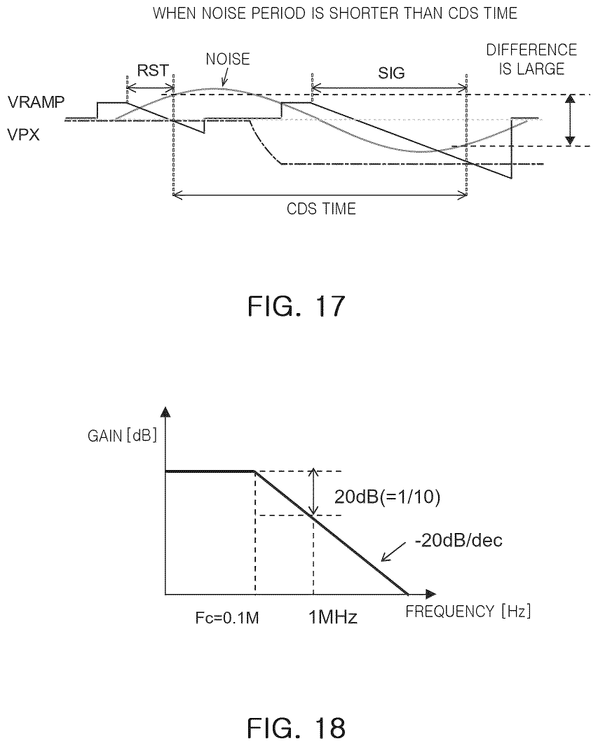

FIG. 16 is a waveform diagram illustrating a ramp signal and a pixel signal when a period of noise is relatively long for a time period of a correlated double sampling operation according to example embodiments. FIG. 17 is a waveform diagram illustrating a ramp signal and a pixel signal when a period of noise is relatively short for a time period of a correlated double sampling operation according to example embodiments. FIG. 18 is a graph indicating gain frequency characteristics of first and second low-pass filter circuits according to example embodiments.

In example embodiments, a cutoff frequency Fc of each of a first LPF 511 and a second LPF 512 may be designed considering the degree to which the voltage fluctuations of the power line 112 may be tolerated.

For example, when the LPF strength is insufficient, that is, when the cutoff frequency Fc is higher than the frequency of the assumed noise, ripples may occur in the error amplifier. As ripples increase, it may be highly likely that errors may occur in the feedback current from the error amplifier. Accordingly, errors may also occur in a voltage drop due to the dummy current for suppressing the voltage fluctuations.

As illustrated in FIG. 16, in the case in which interference occurs in the analog-digital converter portion 13 due to voltage fluctuations of the power line 112, when the period of noise is longer than the CDS time, the noise may be removed by CDS processing. As illustrated in FIG. 17, when the period of noise is shorter than the CDS time, the noise may not be removed by the CDS processing. As described above, when the noise may be suppressed in the CDS time, even when some ripple is input to the error amplifier portion 520, there may be no significant issue.

As illustrated in FIG. 18, when the cutoff frequency Fc is configured to be 1/10 of the CDS frequency (1/CDS time), the noise component of the CDS frequency may be attenuated to 1/10. For example, when the CDS time is 1 μsec (1 MHz), by configuring the cutoff frequency Fc to about 0.1 MHz (100 kHz), which is 1/10 of the CDS frequency, the noise component of the CDS frequency may be expected to be included at about 1/10.

According to the voltage adjusting circuit according to the example embodiments described above, and the image sensor including the voltage adjusting circuit, the effects as below may be obtained.

a dummy current may be generated based on the first voltage applied to the digital circuit portion 200 by the power source and the second voltage generated from the voltage of the power source and used as a reference for the first voltage, and a voltage drop by the dummy current may be applied to the first voltage. Accordingly, the dummy current may be inserted at an appropriate timing while suppressing the consumption power, circuit area, and leakage current increase accompanying the suppression of voltage fluctuations in the power line 111.

Since the voltage of the power line 111 is directly detected and the dummy current is automatically generated according to the detection result, a voltage drop by the dummy current may be applied to the power line 111 at an appropriate timing.

By changing the threshold voltage, the degree of smoothing, that is, the magnitude of the dummy current, may be easily adjusted.

The dummy current generator portion 530 may include a current source formed by an NMOSFET, and may thus be implemented with a small circuit area.

In the semiconductor integrated circuit device 10, since the voltage fluctuations of the power line 111 are reduced, capacitance of the on-chip decoupling capacitor 400 may be lowered, and the on-chip decoupling capacitor 400 may be miniaturized.

Through the package substrate 100, the voltage fluctuations of the power line 112 flowing into the analog circuit portion 300 may be reduced.

Since the voltage fluctuations of the power line 111 are reduced, electromagnetic interference (EMI) may be reduced. Accordingly, electromagnetic interference such as radio frequency (RF) interference may be alleviated.

Since the voltage fluctuations of the power line 111 are reduced, the external low dropout (LDO) response may be stabilized, and the minimum voltage margin may be alleviated.

As described above, a voltage adjusting circuit according to various example embodiments, and an image sensor including the same will be described. However, the example embodiment may be added, modified, and not provided by those skilled in the art in the scope of the technical idea.

For example, in the example embodiment described above, a digital circuit portion is implemented as a load circuit, but example embodiments thereof is not limited thereto, and an analog circuit portion may be present as a load circuit.

Also, in the example embodiment described above, the example in which one voltage adjusting circuit 500 is provided in the semiconductor integrated circuit device 10 is described, but the number of the voltage adjusting circuits 500 provided in the semiconductor integrated circuit device 10 is not limited to one, and the plurality of voltage adjusting circuits may be provided.

Also, in the example embodiment described above, the example in which each of the digital circuit portion 200 and the analog circuit portion 300 is provided to the semiconductor integrated circuit device 10, but the number of the digital circuit portion 200 and the analog circuit portion 300 provided to the semiconductor integrated circuit device 10 is not limited to one, and may be plural.

Also, the image sensor according to example embodiments may be used in various devices sensing light such as visible light, near-infrared light, infrared light, ultraviolet light, and X-rays. Such a device may include, although not limited thereto, a smartphone, mobile phone, personal computer, office device, vehicle-mounted device, medical device, entertainment device, nature observation device, and security device. For example, the image sensor in the example embodiment may be used in a visible light camera such as a smartphone, mobile phone, and digital camera. Also, the image sensor in the example embodiment may be applied to a time of flight (TOF) device or a light detection and ranging (LiDAR) device, along with a light-emitting device.

According to the aforementioned example embodiments, a dummy current may be generated based on the first voltage applied to the load circuit by the power source, and the second voltage generated from the voltage of the power source and used as the reference for the first voltage, and an increase or a decrease of voltage by the dummy current may be applied to the first voltage. Accordingly, the increase in consumed power, the increase in circuit area, and the increase in leakage current appearing in suppressing voltage fluctuations of the power line may be reduced, and the dummy current may be inserted at an appropriate timing.

While the example embodiments have been illustrated and described above, it will be configured as apparent to those skilled in the art that modifications and variations could be made without departing from the scope of the present disclosure as defined by the appended claims.

What is claimed is:

1. A voltage adjusting circuit:
configured to generate a dummy current based on a first voltage applied to a load circuit by a power source, and a second voltage generated from a voltage of the power source and used as a reference for the first voltage, and
configured to suppress fluctuation of the first voltage by applying, to the first voltage, a voltage drop by the dummy current.

2. The voltage adjusting circuit of claim 1 including:
a detector portion configured to detect the fluctuation of the first voltage;
an error amplifier portion configured to adjust a magnitude of the dummy current according to a detection result by the detector portion and the second voltage, and
a dummy current generator portion configured to generate the dummy current having a magnitude adjusted by the error amplifier portion.

3. The voltage adjusting circuit of claim 2 further comprising:
a first level-shift circuit configured to generate a third voltage, which is an input voltage at which the error amplifier portion is able to operate, by using a level of the first voltage; and
a second level-shift circuit configured to generate a fourth voltage, which is an input voltage at which the error amplifier portion is able to operate, by using a level of the second voltage.

4. The voltage adjusting circuit of claim 3,
wherein each of the first level-shift circuit and the second level-shift circuit includes a resistor circuit, a PMOS type circuit, or a source follower circuit,
wherein the first level-shift circuit generates the third voltage from the first voltage by a voltage drop due to a current flowing in the resistor circuit, the PMOS type circuit, or the source follower circuit, and
wherein the second level shift circuit generates the fourth voltage from the second voltage by a voltage drop due to a current flowing in the resistor circuit, the PMOS type circuit, or the source follower circuit.

5. The voltage adjusting circuit of claim 4, further comprising
a smoothing level adjusting circuit configured to adjust a level at which the first voltage is smoothed,
wherein the smoothing level adjusting circuit generates a threshold voltage according to the smoothed level from the second voltage, or the fourth voltage, which is an input voltage at which the error amplifier portion is able to operate.

6. The voltage adjusting circuit of claim 5, wherein the smoothing level adjusting circuit includes a variable resistor circuit or a transistor circuit configured to adjust a current flowing in the second level-shift circuit.

7. The voltage adjusting circuit of claim 2, wherein the detector portion includes a low-pass filter circuit or a peak hold circuit.

8. The voltage adjusting circuit of claim 2, wherein the error amplifier portion includes a plurality of error amplifiers connected to one another in parallel.

9. The voltage adjusting circuit of claim 8, wherein the error amplifier portion is configured to change a number of error amplifiers connected to one another, among the plurality of error amplifiers.

10. The voltage adjusting circuit of one of claim 2, further comprising:
a band adjusting portion configured to adjust a bandwidth of the error amplifier portion.

11. The voltage adjusting circuit of claim 10, wherein the band adjusting portion includes a plurality of band adjusting capacitors connected to one another in parallel.

12. The voltage adjusting circuit of claim 11, wherein the band adjusting portion is configured to change a number of connected band adjusting capacitors connected to one another, among the plurality of band adjustment capacitors.

13. The voltage adjusting circuit of one of claim 2, wherein the dummy current generator portion includes a plurality of NMOSFETs connected to one another in parallel.

14. The voltage adjusting circuit of claim 13, wherein the dummy current generator portion is configured to change a number of connected NMOSFETs connected to one another, among the plurality of NMOSFETs.

15. An image sensor including a digital circuit portion and an analog circuit portion, the image sensor comprising:
a power line configured to apply a first voltage to the digital circuit portion based on a voltage of a power source; and
a voltage adjusting circuit configured to suppress fluctuation of the first voltage,
wherein the voltage adjusting circuit is the voltage adjusting circuit as claimed in claim 1.

16. The image sensor of claim 15, further comprising:
a pixel array including a plurality of pixels,
wherein the analog circuit portion includes a single slope ADC configured to convert an analog pixel signal output by the plurality of pixels into a digital signal, and
wherein the digital circuit portion includes an image signal processing portion configured to process the digital signal obtained by analog-digital converting the analog pixel signal.

17. A voltage adjusting circuit, comprising:
a detector portion configured to generate a first voltage signal detecting a first input voltage corresponding to a first voltage applied to a digital circuit portion, and a second voltage signal detecting a reference input voltage corresponding to a reference voltage different from the first voltage;
an error amplifier portion configured to output an output voltage corresponding to a difference between the first voltage signal and the second voltage signal; and
a dummy current generator portion configured to generate a dummy current causing a voltage drop in the first voltage in response to the output voltage of the error amplifier portion.

18. The voltage adjusting circuit of claim 17, further comprising:
a band adjusting portion connected to an output terminal of the error amplifier portion and including at least one capacitor.

19. The voltage adjusting circuit of claim 18,
wherein the error amplifier portion includes a plurality of error amplifiers connected to one another in parallel,
wherein the dummy current generator portion includes a plurality of current sources connected to one another in parallel, and
wherein and the band adjusting portion includes a plurality of capacitors connected to one another in parallel.

20. The voltage adjusting circuit of claim 17, wherein the dummy current generator portion is connected to the digital circuit portion in parallel.
